(19) United States
(12) Patent Application Publication
(10) Pub. No.: US 2021/0175807 A1
(43) Pub. Date: Jun. 10, 2021

(54) PARTIAL DC/DC BOOST SYSTEM AND METHOD

(71) Applicant: JIANGSU HORIZON NEW ENERGY TECHNOLOGIES CO. LTD., Jingang Town (CN)

(72) Inventor: Gary M. Robb, Honeoye Falls, NY (US)

(21) Appl. No.: 17/111,904

(22) Filed: Dec. 4, 2020

Related U.S. Application Data
(60) Provisional application No. 62/944,014, filed on Dec. 5, 2019.

(51) Int. Cl. H02M 3/24; H02M 1/14; H02P 7/18

(52) U.S. Cl. CPC H02M 3/24; H02P 2201/09; H02P 7/18; H02M 1/14

(57) ABSTRACT

A power conversion system includes a first voltage subsystem, a second voltage subsystem, a power conversion module, and a microcontroller module. The first voltage subsystem has a supply voltage and at least one first filter module. The supply voltage has a first portion and a second portion. The second voltage subsystem includes a converted voltage in series with the second portion of the supply voltage, and a plurality of second filter modules. The power conversion module is configured to convert the first portion of the supply voltage to the converted voltage. The microcontroller module is configured to control the power conversion module.

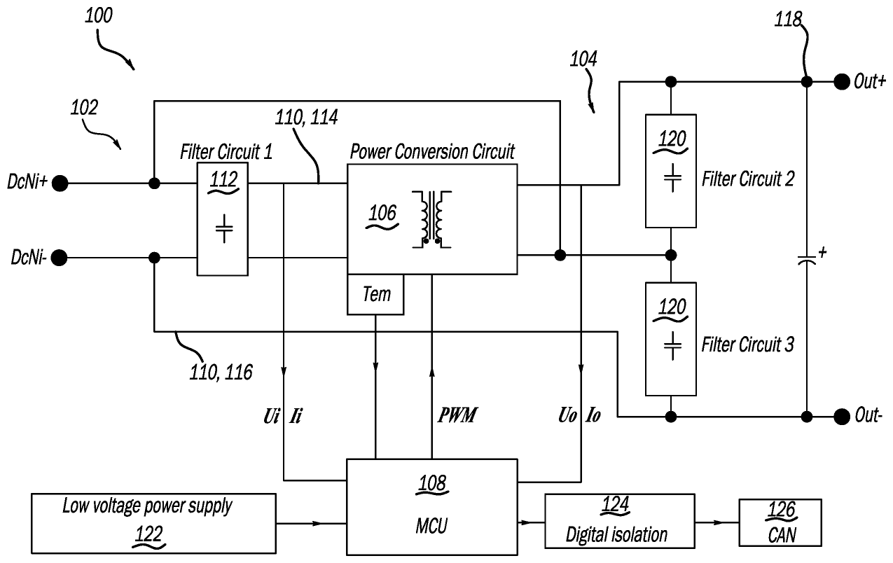

### CROSS-REFERENCE TO RELATED APPLICATIONS

This application claims the benefit of U.S. Provisional Application No. 62/944,014, filed on Dec. 5, 2019. The entire disclosure of the above application is incorporated herein by reference.

### FIELD

The disclosure relates generally to a power conversion system, including a power conversion system including a boost converter for electrically connecting a fuel cell stack to a load.

### INTRODUCTION

This section provides background information related to the present disclosure which is not necessarily prior art.

In certain electrical engineering applications, power conversion can involve converting electric energy from one form to another such as, for example, converting between alternating current (AC) and direct current (DC), or changing voltage or frequency. A DC-to-DC converter can include an electronic circuit or electromechanical device that converts a DC source from one voltage level to another. A boost converter can include a DC-to-DC converter that steps up the voltage while stepping down the current from an input or supply to an output or load.

The boost converter can include a type of switched-mode power supply (SMPS) containing at least two semiconductors, such as a diode and a transistor, and one or more energy storage elements, such as a capacitor and/or an inductor. To reduce periodic variation of the DC voltage, also known as voltage ripple, one or more filters including capacitor(s) and/or inductor(s) can be added to the boost converter at the input (e.g., supply side filter) and/or at the output (e.g., load-side filter).

The boost converter has found certain uses within the fuel cell industry. In particular, various fuel cells provide output power in various ranges of voltages and currents. Boost converters can therefore be used to step the voltage from the fuel cell output to a required voltage of a certain load. For example, a boost converter can be used to convert a 200-300 volt direct current fuel cell output to a higher 400 volt direct current, where the higher output can then be supplied to a high voltage buss that can include a battery and/or a traction motor. Unfortunately, boost converters are known to exhibit power loss from a variety of factors, thereby reducing the efficiency of the overall power system when they are used. For example, power losses can occur from conduction losses, turn on and turn off losses, inductor loss, etc.

There is a continuing need for power conversion systems and methods that militate against power loss associated with the use of DC-to-DC boost converters.

### SUMMARY

In concordance with the instant disclosure, a power conversion system and method that militates against the power loss associated with the conventional use of DC-to-DC boost converters, has been surprisingly discovered.

Power conversion systems and uses thereof are provided that include a first voltage subsystem having a supply voltage. A power conversion module is included that is configured to convert a first portion of the supply voltage from the first voltage system into a converted voltage. A second voltage subsystem is also included that receives the converted voltage from the power conversion module in series with a second portion of the supply voltage from the first voltage system. The power conversion module can include a boost converter and the converted voltage can have a voltage greater than a voltage of the first portion of the supply voltage. Such power conversion systems and uses thereof can include a microcontroller module in electrical communication with the power conversion module, where the microcontroller configured to selectively activate or deactivate the power conversion module. Electrical systems are further provided that include such power conversion systems, where an electrical energy source is electrically connected to the first voltage subsystem and an electrical load is electrically connected to the second voltage. The power conversion system can be configured to have the supply voltage bypass the power conversion module when the voltage level of the supply voltage is the same or greater than a required voltage for the electrical load. For example, the electrical energy source can include a fuel cell stack and the electrical load can include an electric motor, which can further be incorporated into a vehicle.

Also provided are power conversion systems that include a first voltage subsystem, a second voltage subsystem, a power conversion module, and a microcontroller module. The first voltage subsystem can be electrically connected with the power conversion module and the second voltage subsystem. The first voltage subsystem can have a supply voltage and at least one first filter module. The supply voltage can have a first portion and a second portion. The second voltage subsystem can be electrically connected with the power conversion module and the first voltage subsystem. The second voltage subsystem can include a converted voltage in series with the second portion of the supply voltage, and a plurality of second filter modules. The power conversion module can be electrically connected with the first voltage subsystem, the second voltage subsystem, and the microcontroller module. The power conversion module can be configured to convert the first portion of the supply voltage to the converted voltage. The microcontroller can be in electrical communication with the first voltage subsystem, the second voltage subsystem, and the power conversion module. The microcontroller module can be configured to control the power conversion module and can control how much current is in the first portion of the supply voltage.

Further areas of applicability will become apparent from the description provided herein. It should be understood that the description and specific examples are intended for purposes of illustration only and are not intended to limit the scope of the present disclosure.

### DRAWINGS

The drawing described herein is for illustrative purposes only of selected embodiments and not all possible implementations, and is not intended to limit the scope of the present disclosure.

The FIGURE a schematic depicting a power conversion system, according to an embodiment of the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The present technology is drawn to power conversion systems and methods of using such systems that militate against power loss associated with DC-to-DC boost converters. In particular, a high voltage buss can interface with a fuel cell stack, battery, and traction motor. Output of the fuel cell stack can be fed directly to the high voltage buss without passing through a DC-to-DC boost converter, where bypassing the DC-to-DC boost converter can be more efficient. For example, bypassing can be performed when the fuel cell stack voltage is higher than a required buss voltage. Some of the fuel cell stack output can be passed through the DC-to-DC boost converter and then put in series with the fuel cell stack output. In this way, minimizing use of the DC-to-DC boost converter can optimize efficiency and the system can achieves a desired or necessary voltage when the fuel cell stack voltage is lower than the required buss voltage.

Various benefits and advantages are obtained by the present power conversion systems and operation thereof. In particular, by not having the total fuel cell stack output travel through the DC-to-DC boost converter (e.g., maximum of half the fuel cell stack output), the system can employ a smaller, less expensive DC-to-DC boost converter. Likewise, the efficiency of the electrical system can be increased by the minimizing losses associated with DC-to-DC boosting components and operations. Control of the system can be further optimized for efficiency or performance depending on: fuel cell stack power and voltage range; battery capacity, state of charge and voltage range; traction motor power and voltage range; and/or duty cycle requirements.

In certain embodiments, a power conversion system is provided that includes a first voltage subsystem, a power conversion module, and a second voltage subsystem. The first voltage subsystem has a supply voltage, the power conversion module is configured to convert a first portion of the supply voltage from the first voltage system into a converted voltage, and the second voltage subsystem receives the converted voltage from the power conversion module in series with a second portion of the supply voltage from the first voltage system. The power conversion module can include a boost converter and the converted voltage can have a voltage greater than a voltage of the first portion of the supply voltage. The power conversion system can be configured so that the first portion of the supply voltage is less than a total current value of the supply voltage and is greater than zero current.

To reduce periodic variation of DC voltage, also known as voltage ripple, the power conversion system can include one or more filter circuits, where each filter circuit can have one or more capacitors and/or inductors and can be located at the input (e.g., supply side) and/or at the output (e.g., load-side) of the boost converter. Embodiments include where the first voltage subsystem includes a first filter circuit configured to reduce periodic variation of the first portion of the supply voltage. The second voltage subsystem can also include a second filter circuit configured to reduce periodic variation of the converted voltage from the power conversion module and/or a third filter circuit configured to reduce periodic variation of the second portion of the supply voltage from the first voltage system.

A microcontroller module can be provided that is in electrical communication with the power conversion module. The microcontroller module can be configured to selectively activate or deactivate the power conversion module. The microcontroller module can also be in electrical communication with the first voltage subsystem and the second voltage subsystem. In this way, the microcontroller module can be configured to control an amount of current in the first portion of the supply voltage. The microcontroller module, for example, can include a low voltage power supply configured to power the microcontroller module, a digital isolation device configured to allow multiple power domains to coexist and communicate, and a controller area network bus configured to allow the microcontroller module to communicate with other electronic devices without a host computer.

The power conversion system can be employed in various ways. Certain embodiments include various electrical systems that incorporate a power conversion system as described herein. An electrical energy source can be electrically connected to the first voltage subsystem and an electrical load can be electrically connected to the second voltage. Particular embodiments include where the power conversion system is configured to have the supply voltage bypass the power conversion module when the voltage level of the supply voltage is the same or greater than a required voltage for the electrical load. An example of the electrical energy source includes a fuel cell stack and an example of the electrical load includes an electric motor. The electrical system can therefore be used to operate at least a portion of a vehicle, such as an electric vehicle powered at least in part by the electric motor.

In certain embodiments, a method of converting power is provided that utilizes a power conversion system as described herein. A first portion of the supply voltage from the first voltage system can be converted into a converted voltage using the power conversion module. Where a microcontroller module is employed, the power conversion module can be selectively activated/deactivated using the microcontroller module to control how much current is in the first portion of the supply voltage. In particular, the microcontroller module can operate a semiconductor switch in the power conversion module. The microcontroller module can also be operated to optimize efficiency and performance of the power conversion system depending on the supply voltage, the capacity of the load capacity, the state of charging of the load, the voltage range of the load, the motor power of a traction motor, the voltage range of the traction motor, the duty cycle requirements, etc. For example, it is possible to have the supply voltage bypass the power conversion module when the voltage level of the supply voltage is determined to be the same as, or greater than, the required voltage level for the load. In this way, losses associated with DC-to-DC boosting components and operations are minimized.

An embodiment of a power conversion system 100 constructed in accordance with the present technology is shown in the FIGURE. The power conversion system 100 can include a first voltage subsystem 102, a second voltage subsystem 104, a power conversion module 106, and a microcontroller module 108. The power conversion system 100 is configured to convert or “step-up” voltage. This can be desirable for applications where a power source is of a lesser voltage than a load being powered. For example, it can be desirable to have a higher DC voltage to an inverter that supplies AC power to drive a load, such as a main motor for propelling an electric vehicle. At the same time, it can be desirable to provide a relatively low voltage for powering auxiliary or peripheral loads.

The first voltage subsystem 102 can be electrically connected with the power conversion module 106 and the second voltage subsystem 104. The first voltage subsystem 102 can include a supply voltage 110 and at least one first filter module 112 (e.g., filter circuit 1). The supply voltage 110 can be sourced from a supply power source (not shown). The supply power source can include one or more various types of power, such as a fuel cell stack. It should be appreciated that a skilled artisan can select different supply power sources, within the scope of this disclosure. The supply voltage 110 can include a first portion 114 and a second portion 116, where the first portion 114 of the supply voltage 110 can pass through the power conversion module 106, as further discussed herein below. The second portion 116 of the supply voltage 110 can bypass the power conversion module 106, as further discussed herein below. It should be appreciated that a voltage level of the supply voltage 110 can vary, as desired. In addition, a person skilled in the art can divide the supply voltage 110 into additional portions, according to the requirements of one or more desired applications.

The at least one first filter module 112 can provide electrical communication between the supply power source and the power conversion module 106. The at least one first filter module 112 can include one or more capacitors that can optionally be provided in combination with one or more inductors. The at least one first filter module 112 can be configured to militate voltage ripple that can occur from the power conversion module 106. Although one first filter module 112 (e.g., filter circuit 1) has shown to be useful, additional first filter modules 112 can be employed by a skilled artisan, as desired. It should also be appreciated that different filtering techniques and devices can also be employed on the first voltage subsystem 102 according to the requirements of one or more desired applications.

The second voltage subsystem 104 can be electrically connected with the power conversion module 106 and the first voltage subsystem 102. The second voltage subsystem 104 can include a converted voltage 118 and a plurality of second side filter modules 120; e.g., filter circuit 2, filter circuit 3. The converted voltage 118 can be in series with the second portion 116 of the supply voltage 110. The converted voltage 118 can originate from the power conversion module 106, where the power conversion module 106 can convert the first portion 114 of the supply voltage 110 to the converted voltage 118. The converted voltage 118 can have a higher voltage level than the first portion 114 of the supply voltage 110. It should be appreciated that a difference between the converted voltage 118 and the voltage level of the first portion 114 of the supply voltage is scalable according to the desires of a person skilled in the art.

The plurality of second filter modules 120 (e.g., filter circuit 2, filter circuit 3) can provide electrical communication between the power conversion module 106 and the load (not shown). Similar to the at least one filter module 112 (e.g., filter circuit 1), each of the second filter modules 120 (e.g., filter circuit 2, filter circuit 3) can include one or more capacitors that can optionally be provided in combination with one or more inductors. In addition, the plurality of second filter modules 120 can be configured to militate against voltage ripple that can occur from the power conversion module 106. It should be appreciated that the number of the plurality of second filter modules 120 (e.g., filter circuit 2, filter circuit 3) can be scalable by a skilled artisan.

The power conversion module 106 can be electrically connected with the first voltage subsystem 102, the second voltage subsystem 104, and the microcontroller module 108. The power conversion module 106 can be configured to convert or “step-up” the first portion 114 of the supply voltage 110 to the converted voltage 118 that is connected in series with the second portion 116 of the supply voltage 110. It should be appreciated that a certain amount of power from the first portion 114 of the supply voltage 110 can be lost through the conversion process because of the known inefficiencies with DC-to-DC conversion, such as conduction losses, turn on and turn off losses, inductor loss, etc. Notwithstanding, and desirably, less power can be lost overall in the present power conversion system 100 as the second portion 116 of the supply voltage 110 bypasses the power conversion module 106, thereby militating against the known inefficiencies with DC-to-DC conversion. In other words, because the DC-to-DC conversion is just converting the first portion 114 of the supply voltage 110, the necessary voltage for the load is achieved with less power loss through DC-to-DC conversion.

The power conversion module 106 can include a multitude of different electronic circuits or electromechanical devices that convert a source of direct current from one voltage level to another. In particular examples, the power conversion module 106 can include a DC-to-DC boost converter, also known as a step-up converter. The power conversion module 106 can include at least one storage element (not shown) and a semiconductor switch (not shown). The at least one storage element can include a capacitor and an inductor. The semiconductor switch can have an opened state and a closed state. Where the semiconductor switch is in a closed state, the current flows through the inductor in one direction and the inductor stores some energy by generating a magnetic field, for example. Where the semiconductor switch is in an opened state, current can be reduced as the impedance can be higher, where the magnetic field can disappear to maintain the current towards the load. The polarity can therefore be reversed. As a result, two sources can be in series causing a higher voltage to charge the capacitor. It should be appreciated a skilled artisan can employ other boost converter circuits or electromechanical devices, as desired. It should be further appreciated that the power conversion module 106 can be a smaller and less expensive boost converter than used in other applications as only the first portion 114 of the supply voltage 110 passes through the power conversion module; e.g., the power conversion module 106 does not have to be strong enough to support the total value of the supply current 110.

The microcontroller module 108 (MCU) can be in electrical communication with the first voltage subsystem 102, the second voltage subsystem 104, and the power conversion module 106. The microcontroller module 108 can be configured to selectively activate or deactivate the power conversion module 106 and control how much current is in the first portion 114 of the supply voltage 110. In particular examples, the microcontroller module 108 controls the operation of the semiconductor switch in the power conversion module 106. In specific examples, the first portion of the 114 of the supply voltage 110 cannot exceed the total current value of the supply voltage 110 and cannot have zero current. It should be appreciated that the microcontroller module 108 can be optimized for efficiency or performance depending on the supply voltage 110, the capacity of the load capacity, the state of charging of the load, the voltage range of the load, the motor power of a traction motor, the voltage range of the traction motor, the duty cycle requirements, etc. In certain embodiments, the supply voltage 110 can be caused to bypass the power conversion module 106 where the voltage level of the supply voltage 110 is determined to be the same as, or greater than, the required voltage level for the load.

In certain embodiments, the microcontroller module 108 can include a low voltage power supply 122, a digital isolation device 124, and a controller area network (CAN) bus 126. The low voltage power supply 122 can be configured to power the microcontroller module 108. The digital isolation device 124 can be configured to allow for multiple power domains to coexist and communicate, thereby protecting sensitive circuits from switching circuits. The CAN bus 126 can be configured to allow the microcontroller 108 module to communicate with other devices without a host computer.

Advantageously, the power conversion system 100 militates against power loss associated with DC-to-DC boost converters by permitting the first portion 114 of the supply voltage 110 to bypass the power conversion module 106, thereby limiting the amount of the supply current 110 that gets passed through the power conversion module 106 while still reaching the desired voltage for the load.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A power conversion system comprising:
a first voltage subsystem having a supply voltage;
a power conversion module configured to convert a first portion of the supply voltage from the first voltage system into a converted voltage; and
a second voltage subsystem receiving the converted voltage from the power conversion module in series with a second portion of the supply voltage from the first voltage system.

2. The power conversion system of claim 1, wherein the power conversion module includes a boost converter and the converted voltage has a voltage greater than a voltage of the first portion of the supply voltage.

3. The power conversion system of claim 1, wherein the first voltage subsystem includes a first filter circuit configured to reduce periodic variation of the first portion of the supply voltage.

4. The power conversion system of claim 1, wherein the second voltage subsystem includes a second filter circuit configured to reduce periodic variation of the converted voltage from the power conversion module.

5. The power conversion system of claim 1, wherein the second voltage subsystem includes a third filter circuit configured to reduce periodic variation of the second portion of the supply voltage from the first voltage system.

6. The power conversion system of claim 1, wherein the second voltage subsystem includes a second filter circuit configured to reduce periodic variation of the converted voltage from the power conversion module and a third filter circuit configured to reduce periodic variation of the second portion of the supply voltage from the first voltage system.

7. The power conversion system of claim 1, further comprising a microcontroller module in electrical communication with the power conversion module, the microcontroller module configured to selectively activate or deactivate the power conversion module.

8. The power conversion system of claim 7, wherein the microcontroller module is in electrical communication with the first voltage subsystem and the second voltage subsystem.

9. The power conversion system of claim 8, wherein the microcontroller module is configured to control an amount of current in the first portion of the supply voltage.

10. The power conversion system of claim 9, wherein the microcontroller module includes:
a low voltage power supply configured to power the microcontroller module;
a digital isolation device configured to allow multiple power domains to coexist and communicate; and
and a controller area network bus configured to allow the microcontroller module to communicate with other electronic devices without a host computer.

11. The power conversion system of claim 1, wherein the first portion of the supply voltage is less than a total current value of the supply voltage and is greater than zero current.

12. An electrical system comprising:
the power conversion system of claim 1;
an electrical energy source electrically connected to the first voltage subsystem; and
an electrical load electrically connected to the second voltage.

13. The electrical system of claim 12, wherein the power conversion system is configured to have the supply voltage bypass the power conversion module when the voltage level of the supply voltage is the same or greater than a required voltage for the electrical load.

14. The electrical system of claim 12, wherein the electrical energy source includes a fuel cell stack and the electrical load includes an electric motor.

15. A vehicle comprising the electrical system of claim 14.

16. A power conversion system comprising:
a first voltage subsystem, a power conversion module, a second voltage subsystem, and a microcontroller module;
the first voltage subsystem electrically connected with the power conversion module and the second voltage subsystem, the first voltage subsystem having a supply voltage with a first portion and a second portion, and at least one first filter module;
the second voltage subsystem electrically connected with the power conversion module and the first voltage subsystem, the second voltage subsystem having a converted voltage in series with the second portion of the supply voltage, and a plurality of second filter modules;
the power conversion module electrically connected with the first voltage subsystem, the second voltage subsystem, and the microcontroller module, the power conversion module configured to convert the first portion of the supply voltage to the converted voltage; and
the microcontroller module in electrical communication with the first voltage subsystem, the second voltage subsystem, and the power conversion module, the microcontroller module configured to activate or deactivate the power conversion module and control how much current is in the first portion of the supply voltage.

17. The power conversion system of claim 16, wherein the first portion of the supply voltage does not exceed half of a total current value of the supply voltage.

18. The power conversion system of claim 16, wherein the first portion of the supply voltage is greater than zero.

19. The power conversion system of claim 16, wherein the microcontroller module includes a low voltage power supply, a digital isolation device, and a controller area network.

20. A method of converting power comprising:
providing a power conversion system including:
a first voltage subsystem having a supply voltage;
a power conversion module configured to convert a first portion of the supply voltage from the first voltage system into a converted voltage; and
a second voltage subsystem receiving the converted voltage from the power conversion module in series with a second portion of the supply voltage from the first voltage system; and
converting a first portion of the supply voltage from the first voltage system into a converted voltage using the power conversion module.
